(19) United States
(12) Patent Application Publication
(10) Pub. No.: US 2007/0155607 A1
(43) Pub. Date: Jul. 5, 2007

(54) METHOD, APPARATUS AND SYSTEM FOR EVACUATION AND HEAT SEALING

(76) Inventors: Wade M. Bassett, ALBIA, IA (US); Lisa L. Bassett, ALBIA, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/618,128

(22) Filed: Dec. 29, 2006

Related U.S. Application Data
(60) Provisional application No. 60/755,219, filed on Dec. 30, 2005.

(51) Int. Cl. B31B 1/64; B31B 1/80; B65D 33/00

(52) U.S. Cl. 493/133; 493/313; 383/95

(57) ABSTRACT

Heat sealing of a manual closure bag is provided. A compact rotary heat sealing device may be used. The compact rotary heat sealing device includes a slot or other opening for accepting a bag. Rotatable members are positioned along the slot to assist in feeding the bag through the device. A heating element provides for heat sealing the bag. A method of evacuating air from a container includes providing a device comprising a housing and a nozzle having a first end attached to the housing and a second end extending from the housing for placing within the container without requiring the container to come in contact with the housing, inserting the nozzle into the container, evacuating air from the container, sealing the container with a first reusable manual seal, and heat sealing the container.

### CROSS-REFERENCE TO RELATED APPLICATIONS

This application claims priority under 35 U.S.C. § 119 of a provisional application Ser. No. 60/755,219 filed Dec. 30, 2005, which application is hereby incorporated by reference in its entirety.

Although priority is not claimed, this application includes subject matter described in U.S. patent application Ser. No. 11/426,323, which is a divisional of U.S. patent application Ser. No. 10/681,598, now U.S. Pat. No. 7,086,211, all of which are hereby incorporated by reference in their entireties.

### BACKGROUND OF THE INVENTION

The present invention relates to packaging. More particularly, the present invention relates to a method, apparatus and system for a heat sealing device for use with manual closure bags.

Heat sealing devices are used with plastic bags, such as demonstrated by the FOOD SAVER® device. One of the problems with a FOOD SAVER® and similar type devices is that the bags used for heat sealing are specially designed for that purpose and cannot be used for other purposes. That may be advantageous to the manufacturer so that they can profit from add-on sales from the bags, but it is a significant inconvenience for the consumer.

Therefore, it is a primary, object, feature, or advantage of the present invention to provide a method, apparatus and system for a heating sealing device for use with manual closure bags.

It is a further object, feature or advantage of the present invention to improve upon the state of the art.

Another object, feature or advantage to the present invention is to provide an method, apparatus and system for making a long-term storage bag out of an every day, re-usable, manual closure bag.

A further object, feature or advantage of the present invention is to provide a method, apparatus and system for heat sealing that is convenient and inexpensive for consumers.

Yet another object, feature or advantage to the present invention is to provide a method system and apparatus for heat sealing that provides for a long-term storage ability.

A still further object, feature or advantage to the present invention is a method, system and apparatus for sealing a manual closure bag that has been air evacuated.

Another object, feature, or advantage of the present invention is to provide a heat sealable and reusable bag.

One or more of these and/or other objects, features or advantages of the present invention will become apparent from the specification and claims that follow.

### BRIEF SUMMARY OF THE INVENTION

The present invention provides a method, system and apparatus for a heating sealing device using manual closure bags. According to one aspect of the invention a method of providing storage within a manual closure bag includes providing the manual closure bag and then heat sealing the manual closure bag.

According to another aspect of the present invention a method for sealing a bag is provided. The method includes receiving a top portion of the bag in a slot of a compact rotary heat sealing device and then heat sealing the top portion of the bag as a rotatable member of the compact rotary heat sealing device rotates.

According to another aspect of the invention, an apparatus for heat sealing a bag includes a body having a slot for accepting a bag, the bag having a first side and an opposite second side, and a manual closure for closing the bag. The apparatus also includes a heating element disposed within the body for heat sealing the first side to the second side of the bag above the manual closure while the bag is positioned within the slot. The apparatus may be adapted for mounting beneath a kitchen cabinet or kitchen counter. Preferably the apparatus is adapted for rotary feed. The apparatus may include a rotatable member disposed within the body such as a rotary drum, roller, or belt. The rotatable member may have a heat sealing strip to provide the heating element.

According to another aspect of the present invention a sealing device for heat sealing a plastic bag is disclosed. The sealing device includes a body having a slot for accepting a bag. There is a rotatable member disposed within the body. There is also a means for heat sealing the bag operatively connected to the rotatable member and structurally adapted for heat sealing a bag as the rotatable member rotates.

According to another aspect of the present invention a compact rotary heat sealing device includes at least one rotatable member for drawing a bag through the device and a means for heat sealing the bag. A switch, such as a manual switch or a sensor switch may be used to activate a motor and thereby rotate the at least one rotatable member. The at least one rotatable member may include two opposing rotatable members such as two opposing drums, rollers, or belts.

According to another aspect of the present invention a system includes a plastic bag having a first side operatively connected to a second side and a manual seal for manually sealing a plastic reusable bag. The plastic bag has an opening approximate top end and area between the manual seal and the opening. The system also includes an apparatus for heat sealing the plastic bag along at least a portion of the area between the manual seal and the opening.

According to another aspect of the present invention, a manual closure bag is provided. The manual closure bag includes a first side operatively connected to a second side to form a plastic bag having an opening along a top of the bag. The manual closure is positioned between the top of the bag and a bottom of the bag. There is an extended area between the manual closure and the top of the bag to provide sufficient room for heat sealing the manual closure bag without interfering with the manual closure.

According to another aspect of the present invention a method of evacuating air from a container is provided. The method includes providing a device comprising a housing and a nozzle having a first end attached to the housing and a second end extending from the housing for placing within the container without requiring the container to come in contact with the housing. The method further includes inserting the nozzle into the container, evacuating air from the container, sealing the container with a first reusable manual seal, and heat sealing the container.

### BRIEF DESCRIPTION OF THE DRAWINGS

FIG. 1 is a perspective view of one embodiment of a compact rotary heat sealing device according to one embodiment of the present invention.

FIG. 2 is a perspective view of one embodiment of a plastic bag according to the present invention.

FIG. 3 is a perspective view of the device of FIG. 1 being used to heat seal the bag of FIG. 2.

FIG. 4 illustrates the bag of FIG. 2 after heat sealing.

FIG. 5 illustrates one embodiment of a configuration of rollers for use in a rotary heat sealing device.

FIG. 6 is a perspective view of one embodiment of a compact rotary heat sealing device.

FIG. 7 is a perspective view of one embodiment of an air evacuation device with an integrated compact rotary heat sealing device.

FIG. 8 is a perspective view of one embodiment of an under the cabinet or under the counter version of an air evacuation device with an integrated compact rotary heat sealing device.

FIG. 9 is a perspective view of one embodiment of a countertop air evacuation device with an integrated heat sealing device.

FIG. 10 is a perspective view of one embodiment of a compact rotary heat sealing device which includes a cutter for cutting open previously sealed plastic bags.

### DETAILED DESCRIPTION OF AN EXEMPLARY EMBODIMENT

The present invention provides for a device that may be used in conjunction with manual closure bags. In particular, the present invention includes a heat sealing device for use with plastic bags and especially manual closure bags. Preferably, although it is not required, the heat sealing device is a compact rotary device. The heat sealing device of the present invention allows one to make a long-term storage bag out of an everyday bag, including a re-usable manual closure bag.

Preferably, the bags have an extended area above the seal. The heat sealing device can be used with the extended area type of bag or current every-day resealable bags to seal an area above the manual closure. This provides for long-term storage ability. In addition, the heat sealed area can be cut off if desired and the ability to manually close the bag is still maintained. Thus, a bag of the present invention is reusable.

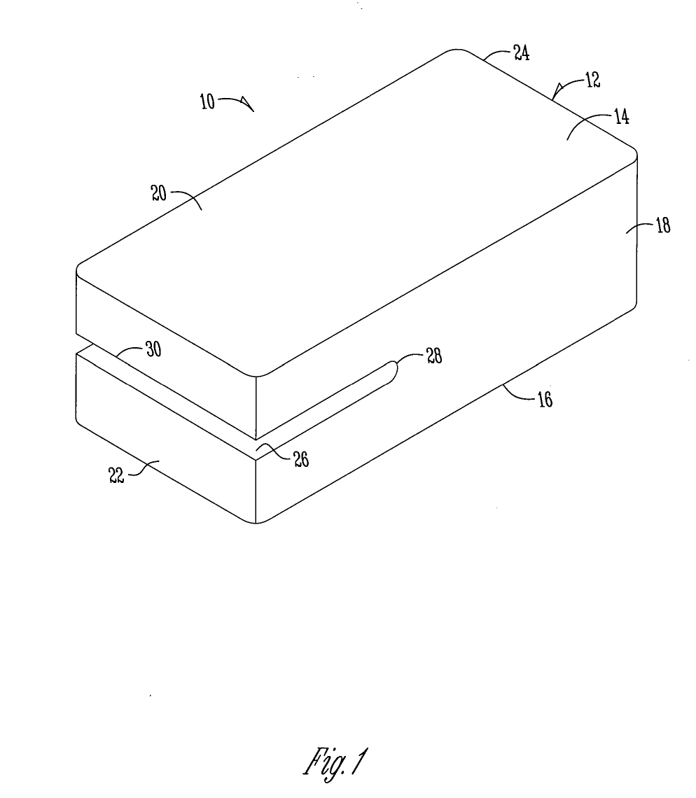

FIG. 1 illustrates a perspective view of one embodiment of a heat sealing device 10 of the present invention. In FIG. 1, the heat sealing device 10 has a body 12. The body 12 has a top side 14, a bottom side 16, and sides 18 and 20. There is a front side 22 and a rear side 24. There is a slot 26 in the body 14 to accommodate receiving of a plastic bag. The slot 26 is open on sides 16 and 20 of the heat sealing device 10 such that a plastic bag can be fed through the heat sealing device 10. Thus, a portion 28 of the slot 26 extends into the first side 16 of the heat sealing device. The slot 26 also has a portion 30 that extends along the front side 22 of the heat sealing device 10. A portion of the slot 26 also extends along the opposite 20 of the heat sealing device 10.

Although preferably a slot is used, the present invention contemplates that another form of an opening could be used. Preferably the heat sealing device 10 is a compact rotary heat sealing device. In such a preferred embodiment, internally there is at least one rotary drum, roller, or belt. For example two rollers can be used that may have a heat sealing strip on them. The present invention contemplates that other sealing methods can be used as the bag moves through the device such as lasers, electrostatic, chemical, heated elements, or others. The compact rotary design allows for any size bag to be heat sealed as the bag is sealed as it passes through the device. The present invention also contemplates that rollers or other automated feeding mechanisms would not be necessary as the bag could simply be manually fed through the device. The use of rollers or other similar feeding mechanisms tend to provide more control and more consistent results. For example, two opposing rotary drums/rollers/belts (or other rotatable members) working together cause the bag to be drawn through the device. As the bag is drawn through the rotating sealing element, preferably, the top portion of the bag is sealed. Additional guides roll/rollers can be used to help feed and align the bag as it is heat sealed may appropriate in particular designs.

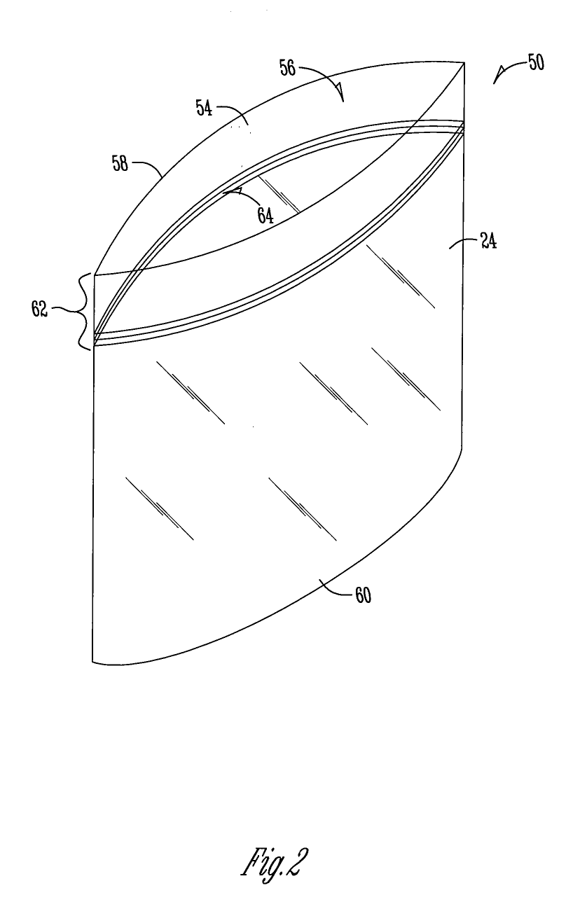

FIG. 2 illustrates one embodiment of a plastic bag of the present invention. In FIG. 2, a bag 50 is shown. The bag 50 has a first side 52 and opposite second side 54 that are operatively connected together to provide an opening 56. The opening 56 is along the top end 58 of the bag 50. The bag 50 also has a bottom end 60. The bag 50 includes a manual closure 64 such as may be known in the art. A portion 62 of the bag extends above the manual closure 64 to the top end 58 of the plastic bag 50. The extended area 62 is provided for heat sealing the bag 50 closed. A portion of the extended area 62 may be patterned or otherwise specially configured to improve the heat seal. The bags themselves may also include designs that assist with the bag alignment as the bag passes through the device such as raised ribs that line up with grooves in the device, rollers, etc.

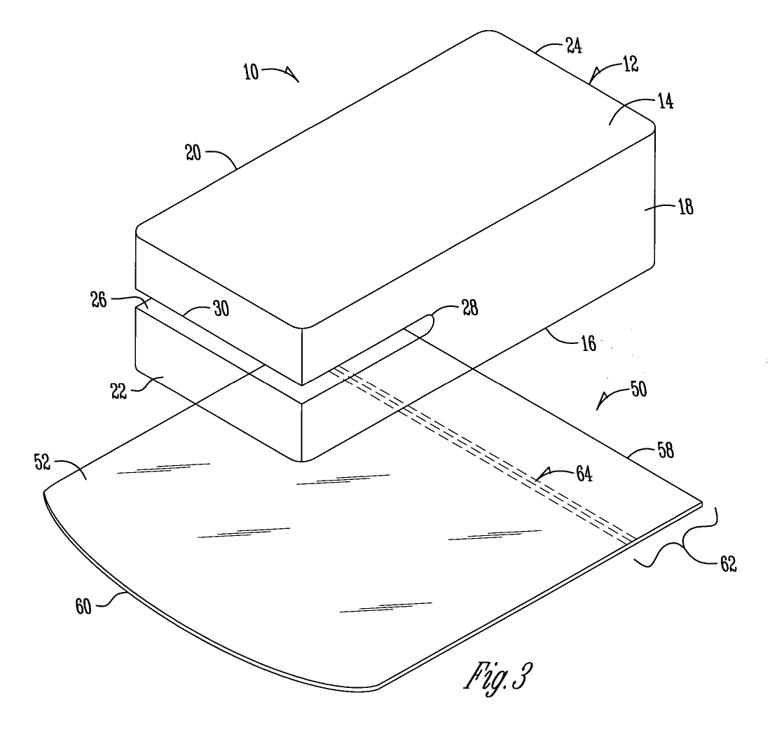

FIG. 3 illustrates the plastic bag 50 positioned within the slot 26 of the heat sealing device 10. Preferably, the plastic bag 50 is manually fed through the slot 26.

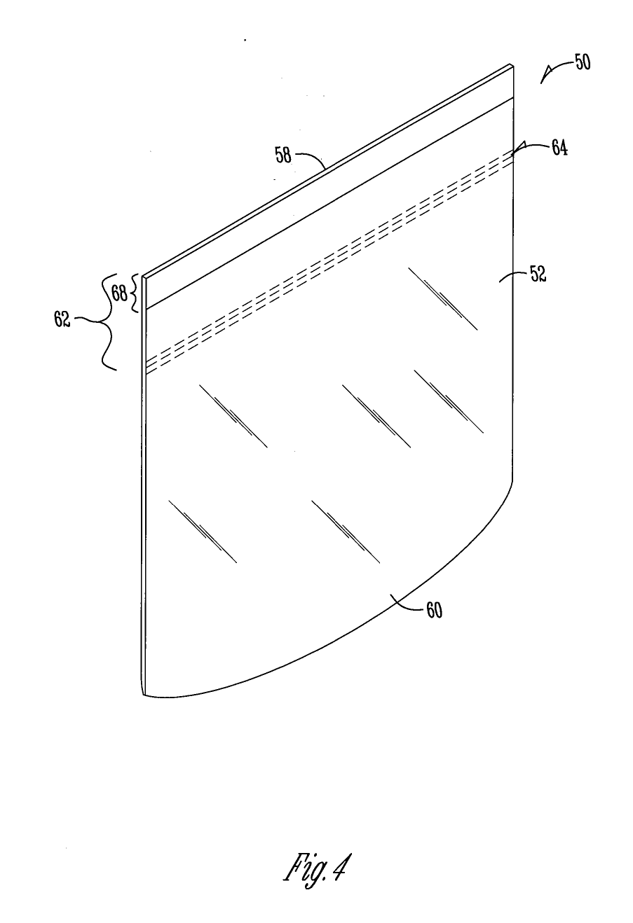

FIG. 4 illustrates the plastic bag 50 after heat sealing. A top most portion 68 of the extended portion 62 is shown to be heat sealed. One of the advantages of this embodiment of the present invention is that a user can cut the heat sealed top most portion 68 off and have enough of the extended portion 62 remaining above the manual closure 64 to re-open and re-seal the bag with the manual closure 64. The plastic bag could even be re-evacuated and closed with the manual closure 64.

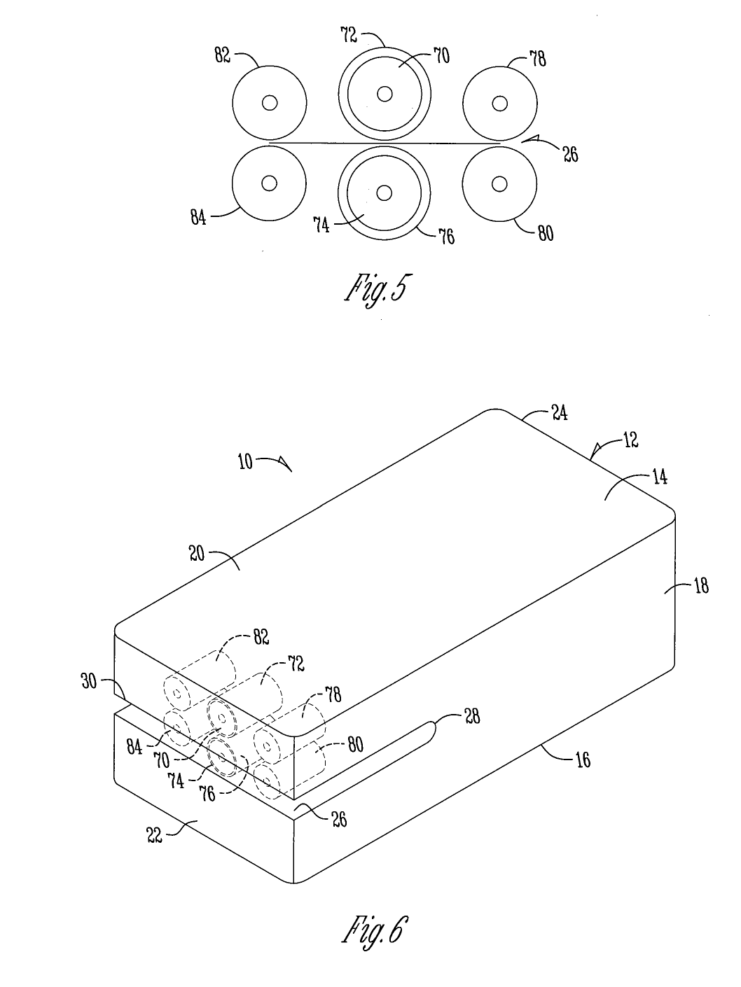

FIG. 5 illustrates one embodiment for a configuration of rollers configured for heat sealing. Of course, the present invention contemplates that other types of rotatable members may be used. A slot 26 is shown which extends between opposite rollers. On top of the slot are guide rollers 78, 82. There is also a roller 70 with heating element 72 shown. The heating element 72 may be a heating strip. On the opposite side of the slot 26 are guide rollers 80, 84. A roller 74 with heating element 76 is positioned between the guide rollers 80, 84.

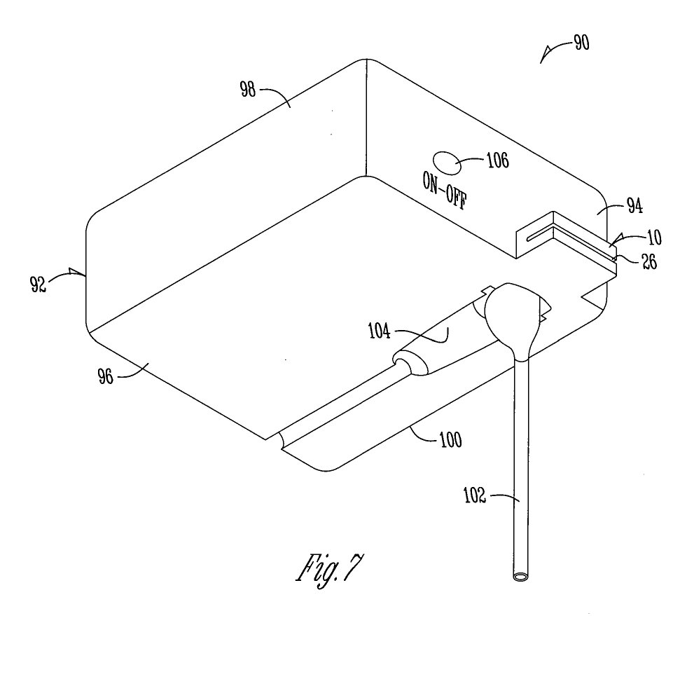

FIG. 6 illustrates one embodiment of the rotary heat sealing device 10 with a set of rollers. In operation, a user inserts a plastic bag through the slot 26. The rollers 78, 80, 82, 84, 70, 74 assist in the feeding of the plastic bag through the compact rotary heat sealer. The heating elements 72, 76 heat the sides or edges of the bag as the bag is fed through the slot 26.

The present invention contemplates numerous advantages. For example, when the compact rotary feed device is used, the device allows for the heat sealing of any size bag without taking up too much space. Heat sealing of the top portion of a closure type bag or a plain bag prevents the bag from being accidentally opened. Heating a closure type bag or a plain bag after air evacuation can greatly improve the long-term vacuum holding capabilities of the bag. The heat sealing device of the present invention can also be used to make custom size open ended bags out of one or more pieces of plastic.

The device itself may also include a switch that starts the device. The switch could be a manual switch or a sensor switch (such as an optical switch) that senses the bag as it is placed in the opening of the device and starts the drive motor and seal element.

Along with sealing any size bag, different thickness of material could be sealed by varying the speed at which the bag is fed, the pressure, and/or the temperature. The present invention also contemplates that the device may have multiple sealing strips for extra protection. The heat sealing device of the present invention can be combined within the same housing as an air evacuator, a FOODSAVER device, a can opener, or other appliance. The disclosure of the air evacuator of U.S. Pat. No. 7,086,211 to Bassett et al. is herein incorporated by reference in its entirety. The heat sealing device can be a counter-top model, under-the-cabinet model, under-the-counter top or wall-mounted. Preferably the device is AC powered due to the heat sealing power demands.

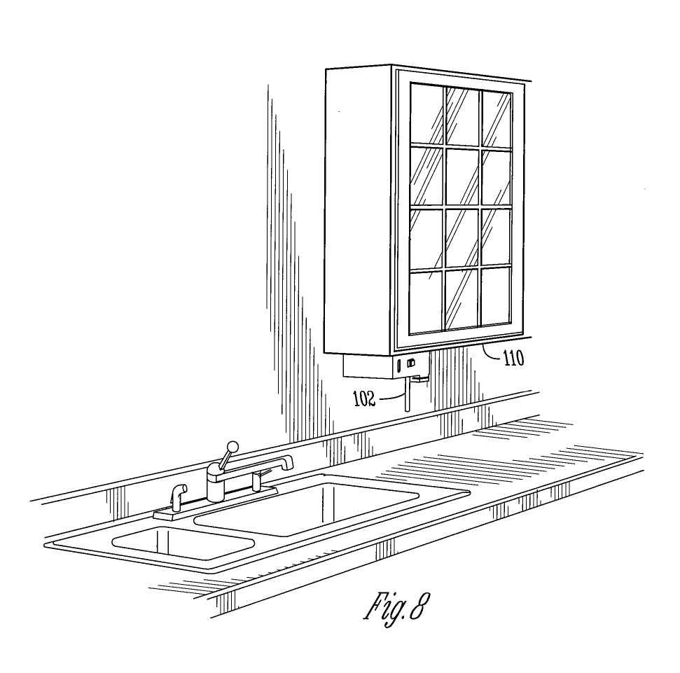

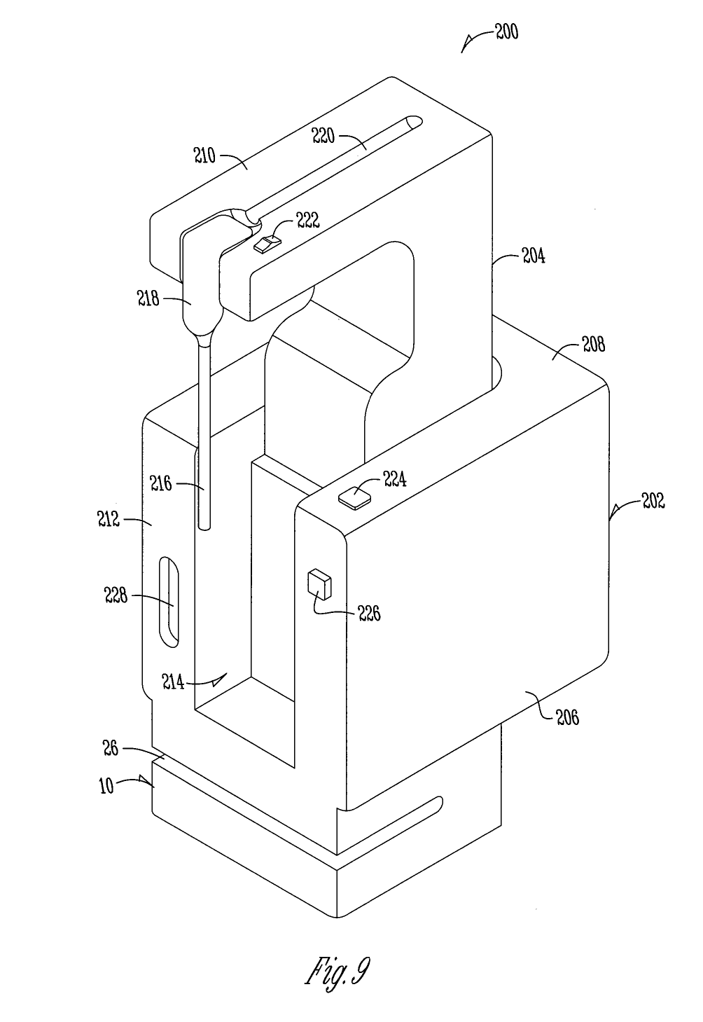

FIG. 7 illustrates one embodiment of an air evacuator which includes a built-in heat sealing device. The device 90 includes a housing 92. The housing 92 includes a front wall 94, a bottom surface 96, and side walls 98 and 100. A nozzle 102 can extend downwardly and outwardly from the housing 92. The nozzle 102 as shown is a foldable nozzle that can also fold back into the recess 104 of the housing 98 when not in use. Preferably, the nozzle 102 is removable and exchangeable with other types of nozzles for cleaning and promoting food safety. A button 106 is shown for turning the device on and off. A compact rotary heat sealer 10 is shown which is integrated with or built-into the device 90. There is a slot 26 in the compact rotary heat sealer 10 that allows a user to run the end of a plastic bag or other container through the heat sealer 10 in order to seal the device. FIG. 8 shows a cabinet with the device of FIG. 7 mounted under the cabinet. Of course the device may also be mounted under a counter.

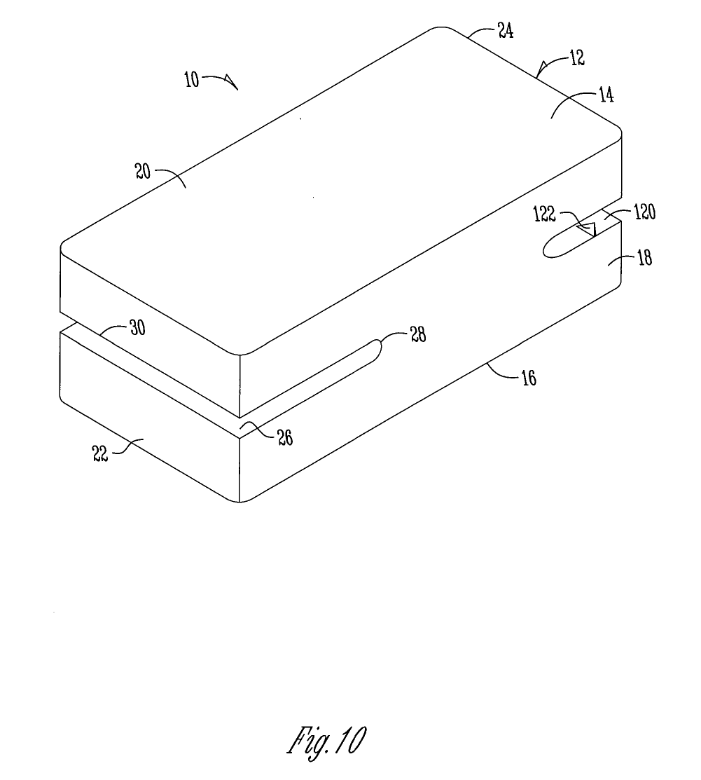

FIG. 9 illustrates one embodiment of a counter-top version of an air evacuator with an integrated heat sealing device. The device 200 shown can be used on top of a counter such as on a counter tip in a kitchen. The device 200 includes a top 209 and a side 206. The device 200 includes a housing 202 having an arm 204 and face of the arm 210. A portion of the housing 202 that does not include the arm 204 can be considered the base portion. A front housing 212 of the device is shown with a recess 214 for containing the arm 204. Attached to the arm 204 is a fitting 218 for a preferably removable nozzle 216. The nozzle 216 can be placed into the recess 220 for storage and compatibility while not in use. A release mechanism 222 is shown to release or lock the nozzle in place. Similarly, a release mechanism 224 for the arm 204 can be used to release the arm 204 prior to transitioning the arm 204 to the upright position. By being able to position the arm 204 and the nozzle 216, the device 200 accommodates containers of various shapes and sizes. The present invention contemplates the ability to use this device with other containers known in the art of evacuation.

Other features of the device 200 include a power button 226. In addition, there is an indicator such as a sigh 228 for determining the level within a separation chamber within the device 200. Although a sight is shown, the present invention contemplates that other types of indicators can be used, including electronic indicators to display or indicate the fill level of the separation chamber, where used. A compact rotary heat sealing device 10 is shown at the bottom of the device 200. There is a slot 26 provided so that a user may slide a plastic bag or other container through the heat sealing device 10.

FIG. 10 provides a perspective view of another embodiment of a heat sealing device 10 but with an optional cutter. The cutter includes a cutting slot 120 and a cutting edge 122. In operation, a user can slide a heat sealed bag through the cutting slot 120 to open the heat sealed bag. A user may then later reseal the bag if desired. A related method includes providing a device comprising a housing and a nozzle having a first end attached to the housing and a second end extending from the housing for placing within the container without requiring the container to come in contact with the housing. The method further includes inserting the nozzle into the container, evacuating air from the container, sealing the container with a first reusable manual seal, and heat sealing the container.

Although the specific embodiments of heat sealing device have been described herein, the present invention is not to be limited to these embodiments. The present invention contemplates numerous variations in the heat sealing device, the plastic bag, and the method of use. These and other variations are well within the spirit and scope of the present invention.

What is claimed is:

1. A method of providing storage within a manual closure bag, comprising:
providing the manual closure bag;
heat sealing the manual closure bag with a rotary heat sealing device.

2. The method of claim 1 wherein the manual closure bag comprises a first side operatively connected to a second side and having a top and a bottom, an opening at the top; a manual seal proximate the top.

3. The method of claim 2 wherein the step of heat sealing heat seals the first sheet to the second sheet above the manual seal.

4. The method of claim 1 further comprising air evacuating the manual closure bag prior to the heat sealing.

5. The method of claim 1 further comprising manually sealing the manual closure bag prior to heat sealing the manual closure bag.

6. A method for sealing a bag comprising:
receiving a top portion of the bag in a slot of a compact rotary heat sealing device;
heat sealing the top portion of the bag as a rotatable member of the compact rotary heat sealing device rotates.

7. The method of claim 6 wherein the bag is a manual closure bag and the bag is manually sealed prior to the step of heat sealing.

8. An apparatus for heat sealing a bag comprising:
a body having a slot for accepting a bag, the bag comprising a first side and an opposite side, and a manual closure for closing the bag;
a heating element disposed within the body for heat sealing the first side to the opposite second side of the bag above the manual closure while the bag is positioned within the slot.

9. The apparatus of claim 8 wherein the body is adapted for mounting beneath a counter.

10. The apparatus of claim 8 further adapted for rotary feed.

11. The apparatus of claim 8 further comprising a rotatable member disposed within the body.

12. The apparatus of claim 11 wherein the rotatable member is a roller.

13. The apparatus of claim 11 further comprising a heat sealing strip on the rotatable member.

14. The apparatus of claim 8 further comprising first and second opposite rotatable members, each of the first and second opposite rotatable members having an attached heat sealing strip.

15. The apparatus of claim 14 further comprising at least one pair of opposite guide rollers on opposite sides of the slot.

16. A system comprising:
a plastic bag comprising a first side operatively connected to a second side and a manual seal for manually sealing the plastic reusable bag;
the plastic bag having an opening proximate a top end and an area between the manual seal and the opening;
an apparatus for heat sealing the plastic bag along at least a portion of the area between the manual seal and the opening, the apparatus having a slot for accepting the bag and a heating element for heat sealing the plastic bag while the bag is positioned within the slot.

17. The system of claim 16 wherein the apparatus further comprises a rotatable member and wherein the heating element is attached to the rotatable member.

18. A method of evacuating air from a container, comprising:
providing a device comprising a housing and a nozzle having a first end attached to the housing and a second end extending from the housing for placing within the container without requiring the container to come in contact with the housing;
inserting the nozzle into the container;
evacuating air from the container;
sealing the container with a first reusable manual seal;
heat sealing the container.
